(19) United States
(12) Patent Application Publication
(10) Pub. No.: US 2018/0326559 A1
(43) Pub. Date: Nov. 15, 2018

(54) PLIERS

(71) Applicant: Chiu-Chi LAI, Taichung City (TW)

(72) Inventor: Chiu-Chi LAI, Taichung City (TW)

(21) Appl. No.: 15/593,945

(22) Filed: May 12, 2017

(51) Int. Cl. B25B 7/12; B25B 7/04

(52) U.S. Cl. CPC B25B 7/123; B25B 7/04

(57) ABSTRACT

A pliers is provided, including a main body, a slidable member, a swingable assembly and a clamp assembly. The slidable assembly is attached to the main body. The swingable assembly includes a swingable member and a connecting member, and the swingable member is pivoted to one of two ends of the slidable member and one of two ends of the connecting member. The clamp assembly includes a first clamp portion and a second clamp portion, and the first clamp portion is disposed on the slidable member.

### BACKGROUND OF THE INVENTION

### Field of the Invention

The present invention relates to a hand tool, and more particularly to a pliers.

### Description of the Prior Art

Generally, a pliers on the market is used to clamp an object. There are many types of tools for dismounting clamps, and one of the tools uses a cable to actuate two clamp portions to clamp the object tightly; however, this type of tool has a complex structure and is uneasy to be assembled or stored. Therefore, for the convenience of usage and storage, most of the clamps on the market form a pliers shape through the combination of two clamp portions and two grip portions so that a user can grip on the grip portion and clamp the object directly. This type of pliers is disclosed in TWM307500.

However, in this type of conventional pliers, a distance between the two clamp portions cannot be adjusted in advance, so every time when the user wants to clamp an object, s/he has to open the clamps to a width matching a width of the object so as to clamp the object. After clamping a great number of objects, the user's hand may sore due to open and close the clamps repeatedly, and it is time-wasting for conducting the repeated actions.

The present invention has arisen to mitigate and/or obviate the afore-described disadvantages.

### SUMMARY OF THE INVENTION

The major object of the present invention is to provide a pliers, a distance between two clamp portions of the pliers can be adjusted in advance, so a user does not need to open and close the two clamp portions in a great degree, and it is energy-saving and efficient for the user to use the pliers. In addition, the pliers has a simple structure and is convenient to use.

To achieve the above and other objects, a pliers is provided, including a main body, a slidable member, a swingable assembly, a first adjustment assembly, a second adjustment assembly and a clamp assembly. The slidable assembly is attached to the main body and slidable along a linear direction. The swingable assembly includes a swingable member and a connecting member, and the swingable member is pivoted to one of two ends of the slidable member and one of two ends of the connecting member. The first adjusting assembly is attached to the main body and optionally movable relative to the main body so as to actuate the other of the two ends of the connecting member opposite to the swingable member. The second adjusting assembly is attached to the main body and optionally movable relative to the main body. The clamp assembly includes a first clamp portion and a second clamp portion, the first clamp portion is comovably disposed on the slidable member, the second clamp portion is comovably disposed on the second adjustment assembly, and the second clamp portion is located on a side of the first clamp portion on the linear direction. When the swingable member relatively moves toward the main body, the swingable member pushes the slidable member toward the second clamp portion; and when the swingable member relatively moves away from the main body, the swingable member pulls the slidable member to move away from the second clamp portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a breakdown view of the first preferred embodiment of the present invention;

FIGS. 3 to 5 are drawings showing the first preferred embodiment of the present invention in operation; and

FIG. 6 is a partial stereogram of the first preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

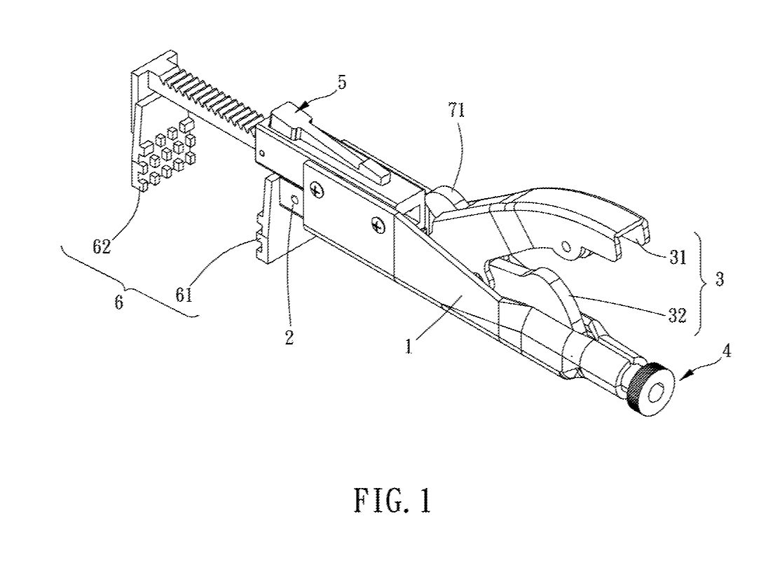

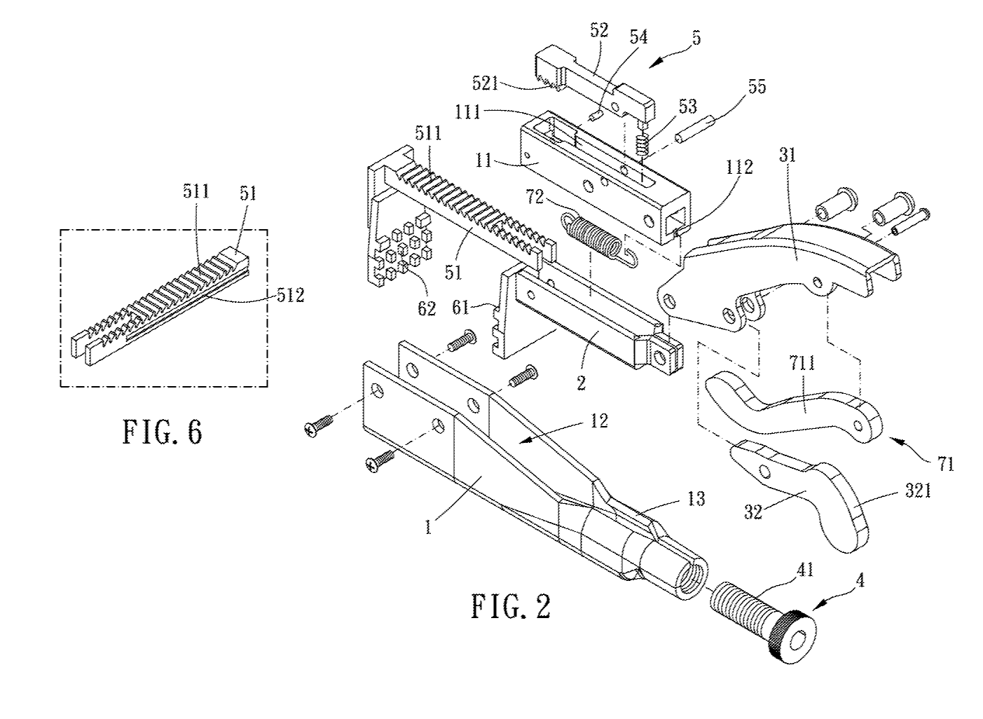

Please refer to FIGS. 1 to 6 for a preferred embodiment, a pliers including a main body 1, a slidable member 2, a swingable assembly 3, a first adjustment assembly 4, a second adjustment assembly 5 and a clamp assembly 6.

The slidable assembly 2 is attached to the main body 1 and slides along a linear direction.

The swingable assembly 3 includes a swingable member 31 and a connecting member 32, and the swingable member 31 is pivoted to one of two ends of the slidable member 2 and one of two ends of the connecting member 32.

The first adjusting assembly 4 is attached to the main body 1 and optionally movable relative to the main body 1 so as to actuate the other of the two ends of the connecting member 32 opposite to the swingable member 31.

The second adjusting assembly 5 is attached to the main body 1 and optionally movable relative to the main body 1.

The clamp assembly 6 includes a first clamp portion 61 and a second clamp portion 62, the first clamp portion 61 is comovably disposed on the slidable member 2, the second clamp portion 62 is comovably disposed on the second adjustment assembly 5, and the second clamp portion 62 is located on a side of the first clamp portion 61 on the linear direction. In this embodiment, one of two ends of the slidable member 2 away from the swingable member 31 is integrally connected to the first clamp portion 61.

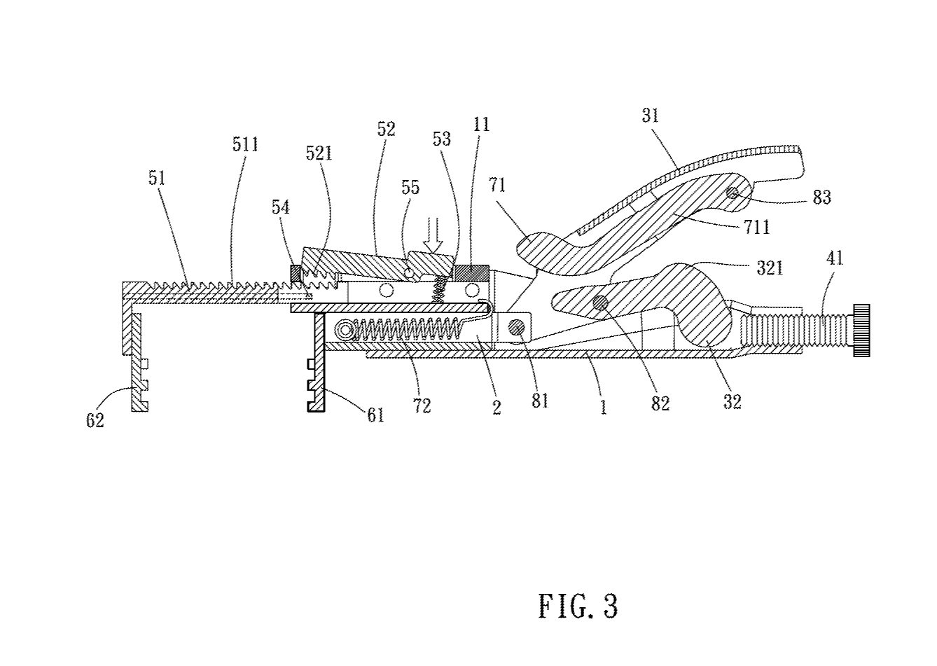

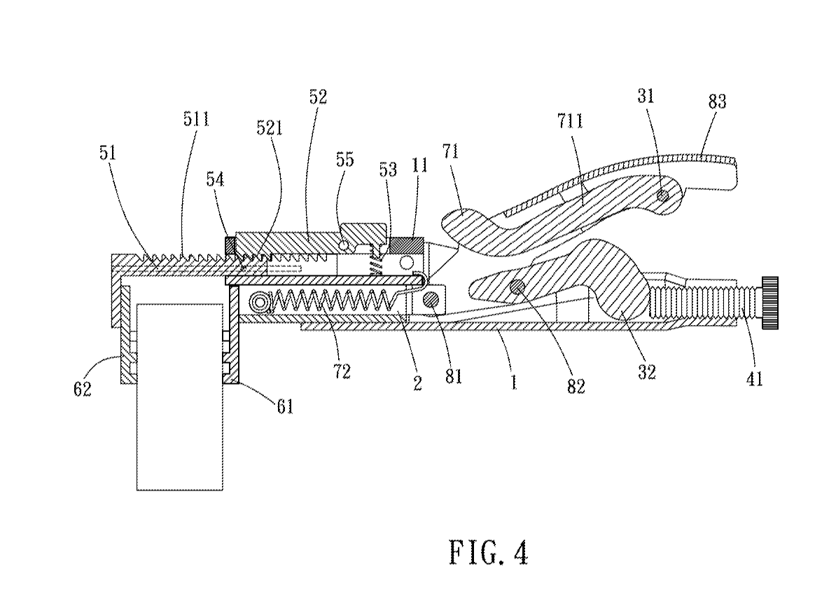

When the swingable member 31 relatively moves toward the main body 1, the swingable member 31 pushes the slidable member 2 toward the second clamp portion 62, and the first and second clamp portions 61, 62 can clamp an object (as shown in FIG. 4); and when the swingable member 31 relatively moves away from the main body 1, the swingable member 31 pulls the slidable member 2 to move away from the second clamp portion 62 to release the object (as shown in FIG. 3).

Furthermore, in this embodiment, the first adjustment assembly 4 includes a first threaded rod 41, and the first threaded rod 41 is screwed with the main body 1 along the linear direction and abuts against the connecting member 32. Through screwing the first threaded rod 41, the first threaded rod 41 moves along the linear direction to adjust positions of the connecting member 32 and the swingable member 31 relative to the main body 1 so as to adjust the positions of the slidable member 2 and the first clamp portion 61 comovable with the slidable member 2 relative to the main body 1.

Specifically, in this embodiment, the second adjustment assembly 5 includes a rod member 51 and an adjusting member 52, the adjusting member 52 is pivoted to the main body 1, the rod member 51 has a first toothed portion 511, the adjusting member 52 has a second toothed portion 521, the second toothed portion 521 normally abuts toward the first toothed portion 511, and the second clamp portion 62 is comovably disposed on the rod member 51. More specifically, the main body 1 further has a position-restricting member 11 fixedly disposed thereon, the rod member 52 is slidably connected to the position-restricting member 11, a pivot axle 55 is disposed through the adjusting member 52 and the position-restricting member 11, a spring 53 elastically abuts against and between the position-restricting member 11 and one of two ends of the adjusting member 52 which is away from the second toothed portion 521, and the pivot axle 55 is located between the second toothed portion 521 and the spring 53 so that the two ends of the adjusting member 52 are in a seesaw state and swingable relative to each other.

Specifically, in this embodiment, the position-restricting member 11 is a rectangular tube, a side of the position-restricting member 11 further has a receiving groove 111, the adjusting member 52 is pivotally arranged within the receiving groove 111, when the second toothed portion 521 abuts against the first toothed portion 511, one of the two ends of the adjusting member 52 which is away from the second toothed portion 521 extends beyond the receiving groove 111, if a user wants to adjust relative positions of the rod member 51 and the position-restricting member 11, the user only needs to press one of the two ends of the adjusting member 52 away from the second toothed portion 521 downward toward the receiving groove 111, the second toothed portion 521 which is at the other of the two ends of the adjusting member 52 upturns and is detached from the first toothed portion 511, and the rod member 51 can slide freely relative to the position-restricting member 11 so as to adjust the relative positions of the rod member 51 and the position-restricting member 11.

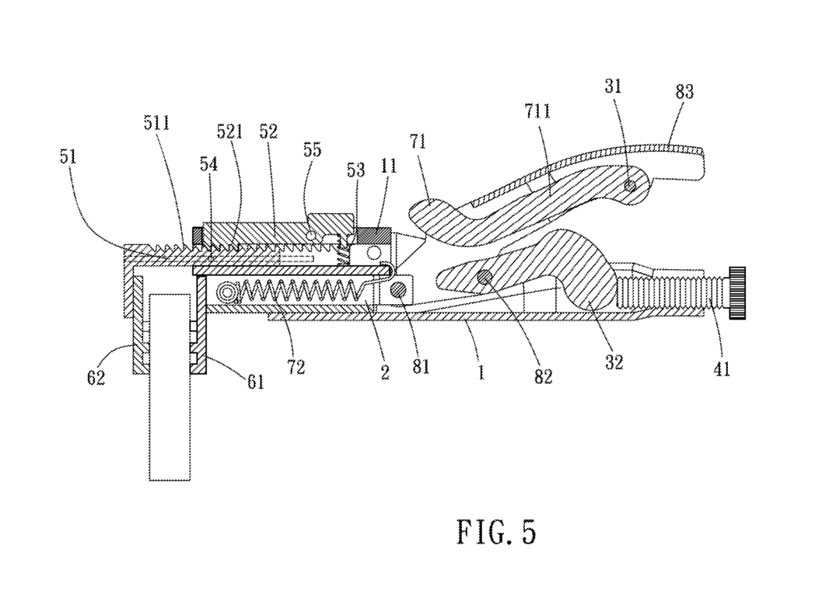

Therefore, through adjusting the first adjustment assembly 4 and the second adjustment assembly 5, the user can adjust, in advance, an initial distance between the first clamp portion 61 and the second clamp portion 62 (that is, when the swingable member 31 and the main body 1 swing toward each other) according to a size of the object (as shown in FIG. 5) so as to prevent the user from hand sore due to opening or closing the first and second clamp portions 61, 62 which are in a great distance.

In this embodiment, the main body 1 is reversed U-shaped board and defines a receiving space 12, the slidable member 2 and the position-restricting member 11 are arranged in the receiving space 12, one of two ends of the main body 1 away from the first clamp portion 61 further has a narrowed section 13, and one of two ends of the connecting member 32 away from the first clamp portion 61 is positioned in the narrowed section 13.

Preferably, the pliers includes an elastic member 72, two ends of the elastic member 72 are respectively arranged between a groove 112 of the position-restricting member 11 (in this embodiment, two ends of the elastic member 72 hook on the groove 112) and the slidable member 2 so that the slidable member 2 has a tendency to move away from the second clamp portion 62; therefore, the user only needs to control the first clamp portion 61 and the second clamp portion 62 to approach each other.

In this embodiment, the rob member 51 further has a position-restricting slot 512 which extends along the linear direction (as shown in FIG. 6), a pin member 54 is disposed through the position-restricting member 11 and abuts against the position-restricting slot 512, and through the pin member 54 cooperating with the position-restricting slot 512, the rod member 51 can be slidably connected to the position-restricting member 11 but cannot be detached from the position-restricting member 11.

It is to be noted that the pliers further includes a toggling member 71, the swingable member 31 and the slidable member 2 are pivoted to a first pivot portion 81, the swingable member 31 and the connecting member 32 are pivoted to a second pivot portion 82, one of two ends of the toggling member 71 and the swingable member 31 are pivoted to a third pivot portion 83, the second pivot portion 82 is located between the first pivot portion 81 and the third pivot portion 83, one of the two ends of the toggling member 71 away from the third pivot portion 83 is a free end, when the swingable member 31 swings toward the main body 1, a middle section 711 of the toggling member 71 between the free end and the third pivot portion 83 abuts against a protrusion 321 of the connecting member 32, when the free end of the toggling member 71 is pressed and swings toward the main body 1, the middle section 711 serves as a fulcrum of the toggling member 71, and the third pivot portion 83 drives the swingable member 31 to swing away from the main body 1 so that the user does not need to change the way s/he grips to control the first and second clamp portions 61, 62 to move away from each other.

Given the above, in the pliers, through adjusting the first and second adjustment assemblies, the user can adjust, in advance, the initial distance between the first clamp portion and the second clamp portion (that is, when the swingable member and the main body swing toward each other) according to the size of the object so as to prevent the user from hand sore due to opening or closing the first and second clamp portions which are in a great distance.

While we have shown and described various embodiments in accordance with the present invention, it should be clear to those skilled in the art that further embodiments may be made without departing from the scope of the present invention.

What is claimed is:

1. A pliers, including:
a main body;
a slidable assembly, attached to the main body and slidable along a linear direction;
a swingable assembly, including a swingable member and a connecting member, the swingable member being pivoted to one of two ends of the slidable member and one of two ends of the connecting member;
a first adjusting assembly, attached to the main body and optionally movable relative to the main body so as to actuate the other of the two ends of the connecting member opposite to the swingable member;
a second adjusting assembly, attached to the main body and optionally movable relative to the main body;
a clamp assembly, including a first clamp portion and a second clamp portion, the first clamp portion being comovably disposed on the slidable member, the second clamp portion being comovably disposed on the second adjustment assembly, the second clamp portion being located on a side of the first clamp portion on the linear direction;
wherein when the swingable member relatively moves toward the main body, the swingable member pushes the slidable member toward the second clamp portion; and when the swingable member relatively moves away from the main body, the swingable member pulls the slidable member to move away from the second clamp portion.

2. The pliers of claim 1, wherein the first adjustment assembly includes a first threaded rod, and the first threaded rod is screwed with the main body along the linear direction and abuts against the connecting member.

3. The pliers of claim 1, wherein the second adjustment assembly includes a rod member and an adjusting member, the adjusting member is pivoted to the main body, the rod member has a first toothed portion, the adjusting member has a second toothed portion, the second toothed portion normally abuts toward the first toothed portion, and the second clamp portion is comovably disposed on the rod member.

4. The pliers of claim 3, wherein the main body further has a position-restricting member fixedly disposed thereon, the rod member is slidably connected to the position-restricting member, a pivot axle is disposed through the adjusting member and the position-restricting member, a spring elastically abuts against and between the position-restricting member and one of two ends of the adjusting member which is away from the second toothed portion, and the pivot axle is located between the second toothed portion and the spring.

5. The pliers of claim 4, wherein the position-restricting member is a rectangular tube, a side of the position-restricting member further has a receiving groove, the adjusting member is pivotally arranged within the receiving groove, and when the second toothed portion abuts against the first toothed portion, one of the two ends of the adjusting member which is away from the second toothed portion extends beyond the receiving groove.

6. The pliers of claim 4, wherein the main body is reversed U-shaped board and defines a receiving space, the slidable member and the position-restricting member are arranged in the receiving space, one of two ends of the main body away from the first clamp portion further has a narrowed section, and one of two ends of the connecting member away from the first clamp portion is positioned at the narrowed section.

7. The pliers of claim 4, further including an elastic member, two ends of the elastic member respectively arranged between a groove of the position-restricting member and the slidable member so that the slidable member has a tendency to move away from the second clamp portion.

8. The pliers of claim 3, wherein the rob member further has a position-restricting slot which extends along the linear direction, and a pin member is disposed through the position-restricting member and abuts against the position-restricting slot.

9. The pliers of claim 1, further including a toggling member, the swingable member and the slidable member being pivoted to a first pivot portion, the swingable member and the connecting member being pivoted to a second pivot portion, one of two ends of the toggling member and the swingable member being pivoted to a third pivot portion, the second pivot portion being located between the first pivot portion and the third pivot portion, one of the two ends of the toggling member away from the third pivot portion being a free end, when the swingable member swings toward the main body, a middle section of toggling member between the free end and the third pivot portion abuts against a protrusion of the connecting member, when the free end of the toggling member is pressed and swings toward the main body, the third pivot portion drives the swingable member to swing away from the main body.

10. The pliers of claim 5, wherein the first adjustment assembly includes a first threaded rod, and the first threaded rod is screwed with the main body along the linear direction and abuts against the connecting member; the main body is reversed U-shaped board and defines a receiving space, the slidable member and the position-restricting member are arranged in the receiving space, one of two ends of the main body away from the first clamp portion further has a narrowed section, and one of two ends of the connecting member is positioned at the narrowed section; the pliers further includes a toggling member, the swingable member and the slidable member are pivoted to a first pivot portion, the swingable member and the connecting member are pivoted to a second pivot portion, one of two ends of the toggling member and the swingable member are pivoted to a third pivot portion, the second pivot portion is located between the first pivot portion and the third pivot portion, one of the two ends of the toggling member away from the third pivot portion is a free end, when the swingable member swings toward the main body and folds up, a middle section is located on the toggling member between the free end and the third pivot portion and abuts against a protrusion of the connecting member, and when the free end of the toggling member is pressed and swings toward the main body, the third pivot portion drives the swingable member to swing away from the main body; one of two ends of the slidable member away from the swingable member is integrally connected to the first clamp portion; the pliers further includes an elastic member, two ends of the elastic member respectively are arranged on the position-restricting member and the slidable member so that the slidable member has a tendency to move away from the second clamp portion.
